(19) United States
(12) Patent Application Publication
(10) Pub. No.: US 2004/0049922 A1
(43) Pub. Date: Mar. 18, 2004

(54) Hair cutting tool

(76) Inventors: Domenic Auriti, Winnipeg (CA); Jaroslav Vydra, Winnipeg (CA)

Correspondence Address: Ryan W Dupuis, Ade & Company, 1700-360 Main Street, Winnepeg, MB, R3C 3Z3, CA

(21) Appl. No.: 10/239,754

(22) PCT Filed: Mar. 28, 2001
(86) PCT No.: PCT/CA01/00571

(51) Int. Cl. B26B 29/00

(52) U.S. Cl. 30/294

(57) ABSTRACT

A cutting tool is provided for cutting hair. The tool includes an elongate handle arranged to mount a blade member formed of glass material on one end thereof. The blade member includes a cutting edge which comprises a fractured edge of the glass material which has been ground so as to be continuous and smooth in profile. A mounting member is provided for selectively mounting the blade member on the handle so as to permit replacement of the blade member when dull. In use the cutting edge is stroked along a person's hair for tapering the ends of the hairs at random lengths to provide texture to the hair.

### FIELD OF THE INVENTION

The present invention relates to a hair cutting tool and to a method of cutting hair using the hair cutting tool.

### BACKGROUND

When cutting hair it is often desirable to texturize the hair to improve the shape and look of the hair. Texturizing generally involves cutting the hair at random lengths by cutting the hair at various angles relative to the hair or by using specially adapted scissors having notched blades. The use of a razor is also known for texturizing hair by stroking the hair at random angles and lengths. The use of known hair cutting tools such as scissors or a razor however, results in a cut end which is stiff and blunt. The clean cutting edges of the scissors and razor respectively limits the randomising effect of the texturizing action. This is undesirable in instances when the purpose of the texturizing effect is to soften and randomly taper the hair ends at varying random lengths.

### SUMMARY

According to one aspect of the present invention there is provided a tool for cutting hair comprising:

an elongate handle extending in a longitudinal direction from a gripping end to a working end; and

a blade member formed of glass material and being mounted on the working end of the handle, the blade member being oriented to project laterally outwardly from the handle to an elongate cutting edge.

The resulting degree of sharpness of the glass blade, when stroked longitudinally along a person's hair, gradually cuts away a portion of the thickness of the hair so as to produce random tapers of hair at random lengths of the hair instead of blunt cut ends as occurs with a razor stroke for example. The orientation of the blade in relation to the handle readily permits the blade to engage the hair at an effective angle for texturizing the hair. The resulting texturizing action of the hair cutting tool softens the hair by tapering the hair ends to vary thickness and rigidity of the hair while randomly cutting the hair at different lengths due to the cutting edge being formed of suitable glass material.

At least a portion of the cutting edge preferably extends in the longitudinal direction of the handle. The cutting edge is preferably formed by honing a fractured edge of the glass material so as to have a smooth and continuous curved profile. When the cutting edge is defined at an intersection of two surfaces of the glass material, the two surfaces are preferably oriented at an angle substantially less than 90 degrees in relation to one another. All edges of the blade member other than the cutting edge are preferably honed so as to be dull. In a preferred embodiment the material consists of jade crystal, however any glass-like material or ceramic related material would be suitable.

There may be provided a mounting member arranged to selectively mount the blade member on the working end of the handle which permits the blade member to be selectively separated from the handle for replacement thereof. In one arrangement, the mounting member comprises a clamping member mounted on the blade member and being arranged to be selectively clamped on the working end of the handle.

The blade member may be supported on the handle for sliding movement in the longitudinal direction of the handle between a working position mounted on the working end of the handle and a released position in which the blade member is released from the working end of the handle. Preferably, the blade member is slidable towards the released position only in a direction corresponding to being displaced towards the gripping end of the handle.

According to a further aspect of the present invention ther is provided a method of cutting hair comprising:

providing a blade member formed of glass material having a cutting edge defined at an intersection of two surfaces of the glass material;

positioning a plurality of hairs to extend in a substantially common longitudinal direction;

positioning the blade member adjacent the hair;

orienting the cutting edge to extend transversely to the longitudinal direction of the plurality of hairs; and

cutting away a portion of the plurality of hairs by stroking the cutting edge along the plurality of hairs in the longitudinal direction of the plurality of hairs.

The method preferably includes twisting the plurality of hairs about an axis extending in the substantially common longitudinal direction before positioning the blade member adjacent the hair. Twisting the hair exposes hairs of different depth and secures the hair more rigidly for effective randomized cutting of the hair.

The cutting edge is preferably oriented to face a direction of travel of the cutting edge when the cutting edge is stroked along the plurality of hairs with an innermost one of the surfaces which is adjacent the plurality of hairs being at an angle substantially less than 90 degrees in relation to the longitudinal direction of the plurality of hairs.

When blade member is supported on a handle, the method preferably includes replacing the blade member on the handle when the cutting edge becomes wom.

The method may further include forming the cutting edge by fracturing the glass material before cutting the hair. The resulting fractured edge of the glass material is preferably honed such that the cutting edge has a smooth and continuous profile. In further arrangements however, it may be desirable to fracture or hone the cutting edge of the glass material so as to define a cutting edge having an irregular profile consisting of random sharp and blunt serrations. Different cutting edge configurations will provide differing cutting characteristics as well as different wear characteristics which affect blade life.

### BRIEF DESCRIPTION OF THE DRAWINGS

In the accompanying drawings, which illustrate an exemplary embodiment of the present invention:

FIG. 1 is an isometric view of the hair cutting tool shown being stroked along a plurality of hairs to be texturized.

FIG. 2 is an end view of the tool according to FIG. 1.

FIG. 3 is a sectional view along the line 3-3 of FIG. 2.

FIGS. 4A and 4B are respective isometric views of a strand of hair before and after the hair has been cut by the hair cutting tool.

### DETAILED DESCRIPTION

Referring to the accompanying drawings, there is illustrated a hair cutting tool generally indicated by reference numeral 10. The hair cutting tool is for use in fine texturing of hair by tapering the hair ends at random lengths.

The hair cutting tool generally comprises a handle 12 extending in a longitudinal direction from a working end 14 to a gripping end 16. A blade member 18 is mounted on the working end of the handle for engaging the hair when the gripping end is supported in a person's hand.

The blade member 18 consists of jade crystal which has been fractured and formed to have a tapered arcuate profile 20 which defines a cutting edge 22 of the blade member. The cutting edge 22 extends along an outward first side of the blade member spaced laterally outwardly from the handle and opposite a blunt face 24 on an inner second side of the blade member adjacent the handle. The cutting edge is oriented such that at least a portion of the edge extends substantially in the longitudinal direction of the handle when the blade member is supported on the handle. The blunt face 24 is configured for selective mounting on the working end of the handle as later described herein.

The blade member further includes a flat top face 28 and a substantially flat bottom face 30 in parallel relationship, both extending laterally outwardly from the handle from the inner side to the outer side of the blade member. The upwardly facing top face 28, at an outer side thereof, includes a tapered surface 32 which tapers downwardly and outwardly along the arcuate profile 20, projecting laterally outwards from the handle towards the cutting edge 22 which lies in a common plane with the flat bottom face 30. The cutting edge is thus defined at an intersection between the flat bottom face 30 and the tapered surface 32 extending between the top face and bottom face an angle substantially less than 90 degrees in relation to the bottom face.

A clamp member 34 is provided for mounting the blade member 18 on the handle. The clamp member 34 is a U-shaped channel having a base portion 36 which is secured to the blunt face 24 of the blade member using glue or any other suitable fastener. A pair of side flanges 38 extend outwardly from the blunt face 24 on opposing sides of the base portion 36. The side flanges 38 are tensioned towards one another so as to extend outwardly from the blunt face 24 at an incline towards one another in an unsprung position. The side flanges 38 are thus suitably arranged for selectively clamping a portion of the handle 12 therebetween.

The handle 12 is formed of an elongate and flat member of rigid material, for example either glass or metal, defining a top face 40 and a bottom face 42 of the handle. The top and bottom faces 40 and 42 extend between respective ends of the handle and define an outer side 44 of the handle which is curved outwardly opposite the blade member 18 secured on the handle. An inner side 46 of the handle secures the blade member 18 thereon and includes a central portion 48 which is curved inwardly so as to be contoured to receive a person's fingers therein when the handle is gripped in the person's hand. The inner side 46 adjacent the working end 14 of the handle includes a protrusion 50 which projects laterally outwardly from the inner side 46 of the handle for mounting the blade member 18 thereon. The protrusion 50 is substantially identical in thickness to a main portion of the handle between the respective top and bottom faces thereof.

A pair of grooves 52 extend across the protrusion 50 in the longitudinal direction of the handle 12. The pair of grooves 52 are located in the top and bottom faces 40 and 42 respectively and are aligned with one another for slidably receiving the clamping member 34 of the blade member therein. The grooves each extend in the longitudinal direction from a mouth 54 at an edge of the protrusion 50 nearest the gripping end of the handle to a terminal end 56 adjacent to the working end of the handle. The blade member 18 is secured to the handle 12 by inserting the respective side flanges 38 of the clamp member within the respective grooves 52 at the mouth 54 thereof. The clamping member 34 is thus slidable along the grooves 52 in the longitudinal direction of the handle from a released position adjacent the mouth 54 of the grooves wherein the blade member is permitted to be released from the handle to a working position adjacent the terminal end 56 of the grooves.

In the working position the terminal end 56 of the grooves restricts further sliding movement of the blade member towards the working end of the handle, permitting sliding movement only towards the gripping end of the handle where the blade member is permitted to be released from the handle. The grooves 52 are deepest at the mouth 54 thereof and become more shallow as they extend towards the terminal end 56 thereof adjacent the working end of the handle such that the thickness of the protrusion 50 between the top and bottom faces of the handle within the grooves increases from the mouth to the terminal end of the grooves. As the blade member is slidably displaced from the released position to the working position the increased thickness of the handle between the grooves forces the side flanges 38 of the clamp member apart under tension to secure the blade member to the handle by wedging action of the grooves 52 within the clamping member 34. As shown in FIG. 3, the thickness between the grooves 52 adjacent the mouth 54 thereof is narrower than the spacing between the respective free ends of the side flanges 38 in the unsprung position such that the clamping member provides little or no clamping force onto the handle in the released position of the blade member, thus permitting the blade member to be released from the handle in the released position.

The blade member is thus well suited for replacement when dull or for providing different cutting configurations by replacement of the blade member with a blade member having a differing cutting edge profile. The cutting edge 22 in one arrangement is formed by randomly chipping and serrating the edge with a file or other similar tool to form an irregular profile of random sharpened and blunt serrations of fractured glass having varying degrees of sharpness along the cutting edge. As illustrated in the accompanying figures, the cutting edge is formed in a smooth and continuous sharpened edge which is curved in profile by further honing or grinding operations.

In order to form the blade member of glass material, a sheet of jade crystal, or other suitable material, is fractured into two or more pieces. A selected one of the pieces is arranged to form a blade member having at least one cutting edge thereon using honing and grinding operations. The cutting edge is honed and tapered so as to define the generally arcuate profile 20 along one side thereof. Any extraneous sharp edges, namely all edges other than the cutting edge, are cut off or dulled using a diamond blade or polished using a polishing wheel so as to define the substantially flat top and bottom faces 28 and 30 of the blade member. The blunt face 24 is also formed so as to be configured for mounting on the handle. Further sandblasting operations can be used to smooth out any remaining rough edges. The blade member is thus arranged to be mounted on the handle to define the tool as shown in the attached figures.

The cutting edge 22 may subsequently be customized as desired depending on the cutting effect which is desired by the user. The edge may be honed to form the continuous sharp edge mentioned above or to form the irregular profile having varying degrees of sharpness by chipping and filing the cutting edge also described above. A smooth and continuous sharp edge will generally have better wear characteristics and a longer life, but an irregular profile can be desirable when particular texturizing is desired. To maintain a smooth and continuous sharp edge, the blade is replaced when dull with a new sharp replacement blade having a similar configuration of clamping member 34 thereon.

In use a person first positions the hairs 64 to be texturized to extend in a substantially common longitudinal direction about a longitudinal axis 66 thereof. Before the cutting operation begins the user may optionally twist the hair about the longitudinal axis which assists in holding the hair tighter while providing a more random texturizing effect by exposing hairs of plural depths to the surface of the plurality of hairs to be cut.

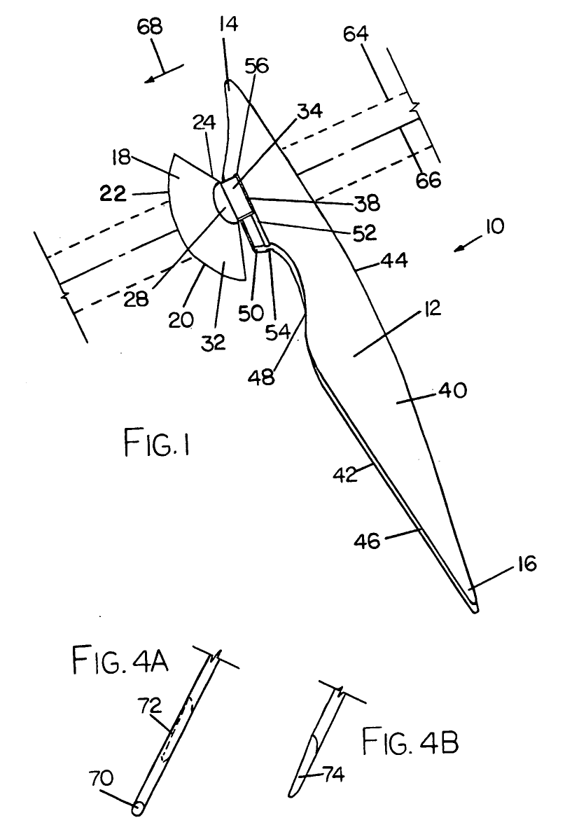

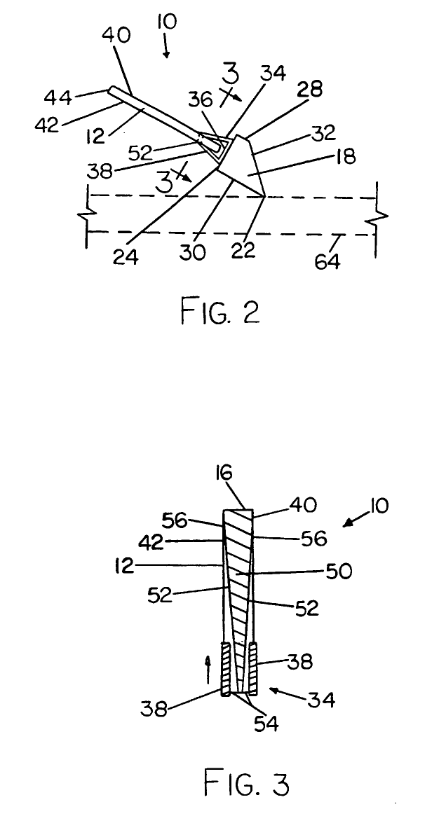

As shown in FIG. 1, the cutting edge is positioned adjacent the hair and oriented transversely to the longitudinal axis thereof so as to be positioned to cut the hair. The cutting edge is oriented to face a direction of travel of the cutting edge when the cutting edge is stroked along the plurality of hairs with the flat bottom face 30 adjacent the plurality of hairs at an angle substantially less than 90 degrees in relation to the longitudinal direction of the plurality of hairs, as best illustrated in FIG. 2.

The tool is stroked longitudinally along the hair in the direction as indicated by the arrow 68 to randomly shave down the thickness of individual hairs while cutting others at random lengths simultaneously depending upon the varying angle between the hairs and the cutting edge as well as the varying degree of sharpness of the blade after repeated use thereof. The hair is thus finely texturized by tapering the hairs over a substantial length of the hair at random lengths thereof such that the hair is softened and texturized in an optimal manner.

In use the jade crystal cutting edge 22 continuously varies in sharpness along the profile thereof so as to provide fresh alternating sharp and blunt edges with use. The use of the tool is generally sufficient to maintain a desired degree of sharpness of the blade however the user may choose to customize the varying degrees of sharpness of the cutting edge at any time desired or replace the blade entirely as desired. When customizing, the user may thus choose to file or chip the edge to provide the desired degree of randomness or sharpness to the cutting edge. When filing the blade, a file is most effective when stroked transversely across the cutting edge of the blade, away from the cutting edge as opposed to stroking into the cutting edge.

The hair cutting tool thus provides a unique manner of texturizing hair without completely severing or cutting away the hair in a single stroke. In contrast when using texturizing scissors or a razor blade with random strokes the resulting hair is cut at blunt lengths which differ significantly from the long flowing tapers and randomized cutting of the hair cutting tool 10 of the present invention. As shown in FIG. 4A a hair is shown with a blunt end 70 which has been cut by a razor or scissors wherein the dotted line 72 indicates the cutting line of the tool 10. The resulting tapered end 74 is shown in FIG. 4B.

While one embodiment of the present invention has been described in the foregoing, it is to be understood that other embodiments are possible within the scope of the invention. The invention is to be considered limited solely by the scope of the appended claims.

1. A tool for cutting hair comprising:
an elongate handle extending in a longitudinal direction from a gripping end to a working end; and
a blade member being formed of a glass material and being mounted on the working end of the handle, the blade member including two surfaces oriented to project generally laterally outwardly from the handle to an elongate cutting edge defined at an intersection of the two surfaces of the glass material, at least a portion of the cutting edge extending generally in the longitudinal direction of the handle;
the cutting edge comprising a fractured edge of the glass material;
characterised in that the fractured edge of the glass material is shaped to be curved along a smooth and continuous profile.

2. The tool according to claim 1 wherein there is provided a mounting member arranged to selectively mount the blade member on the working end of the handle permitting the blade member to be selectively separated from the handle for replacement thereof.

3. The tool according to claim 1 wherein the mounting member comprises a clamping member mounted on the blade member and being arranged to be selectively clamped on the working end of the handle.

4. The tool according to claim 1 wherein the blade member is supported on the handle for sliding movement between a working position mounted on the working end of the handle and a released position in which the blade member is released from the working end of the handle.

5. The tool according to claim 4 wherein the blade member is supported for sliding movement in the longitudinal direction of the handle.

6. The tool according to claim 5 wherein the blade member in the working position is slidable towards the released position only in a direction corresponding to being displaced towards the gripping end of the handle.

7. The tool according to claim 1 wherein the two surfaces of the glass material are oriented at an angle substantially less than 90 degrees in relation to one another.

8. The tool according to claim 1 wherein all edges of the blade member other than the cutting edge are dull.

9. The tool according to claim 1 wherein the blade member consists of jade crystal.
